(19) United States
(12) Patent Application Publication
(10) Pub. No.: US 2006/0172141 A1
(43) Pub. Date: Aug. 3, 2006

(54) Joints and methods of making and using

(76) Inventors: Xinyu Huang, Willington, CT (US); Kenneth L. Reifsnider, Storrs, CT (US); Raymond Oliver England, Harnsville, RI (US); Yanhai Du, East Amherst, NY (US)

Correspondence Address: CANTOR COLBURN, LLP, 55 GRIFFIN ROAD SOUTH, BLOOMFIELD, CT, 06002, US

(21) Appl. No.: 11/341,140

(22) Filed: Jan. 27, 2006

Related U.S. Application Data
(60) Provisional application No. 60/648,019, filed on Jan. 27, 2005.

(51) Int. Cl. B32B 15/04; B32B 9/00; B32B 19/00

(52) U.S. Cl. 428/469; 428/472; 428/701; 428/702

(57) ABSTRACT

A joint comprises a first structural element, a second structural element and a seal intermediate between the first structural element and the second structural element. The seal comprises a first porous ceramic film disposed on the first structural element, a second porous ceramic film disposed on the second structural element and adjacent to the first porous ceramic film, and a filler material, wherein the filler material is interposed between the first porous ceramic film and the second porous ceramic film and/or impregnated into at least a portion of pores of the first porous ceramic film and the second porous ceramic film.

### CROSS REFERENCE TO RELATED APPLICATIONS

The present application relates to, and claims the benefit of, U.S. Provisional Patent Application No. 60/607,496, which was filed on Jan. 27, 2005 and is incorporated herein in its entirety.

### STATEMENT REGARDING FEDERALLY SPONSORED RESEARCH

The United States Government has certain rights in this invention pursuant to Department of Energy Grant No. DE-FC26-04NT42228.

### BACKGROUND

Affordable and reliable fuel cells are widely sought after as next-generation power sources for many applications. However, despite their desirability, several obstacles remain to the development of a commercially viable fuel cell. For example, many fuel cells operate at elevated temperatures (e.g., greater than about 500° C.), which preclude sealing materials such as rubber or plastic from being used between the various fuel cell system elements. Maintaining stable hermetic or substantially-hermetic seals is critical to the safety and performance of a fuel cell since these seals may be used in part to prevent reactants from leaking out of the compartments in which they were intended to be contained. To fulfill these functions, the seal materials should be mechanically and chemically compatible with other cell components.

To date, two types of seals that have been investigated for solid oxide fuel cell applications include bonded seals and compressive seals. In a bonded seal, the elements to be sealed are jointed by a filler material such as a glass, glass-ceramic, or metal braze. These seals may perform well under steady-state conditions, but generally have poor thermal cycling stability under transient conditions such as during start-up and shut-down. Furthermore, some glass materials react with metallic separator plates to form a weak interfacial layer. With a compressive seal, the seal material, which is commonly a form of mica, is sandwiched in between the elements to be sealed. While these seals may have better thermal cycling stability, they can require relatively large compressive forces to obtain a good seal in addition to developing leaks along the cleave planes of the mica.

There accordingly remains a need in the art for new and improved seals that maintain their structural and chemical stability under steady state and transient operating conditions.

### SUMMARY

Disclosed herein is a joint, which includes a first structural element, a second structural element and a seal intermediate between the first structural element and the second structural element. The seal includes a first porous ceramic film disposed on the first structural element, a second porous ceramic film disposed on the second structural element and adjacent to the first porous ceramic film, and a filler material, wherein the filler material is interposed between the first porous ceramic film and the second porous ceramic film and/or impregnated into at least a portion of pores of the first porous ceramic film and the second porous ceramic film.

In another embodiment, a fuel cell comprises a fuel cell housing; an anode; a cathode; an electrolyte, wherein the anode and the cathode are on opposite sides of the electrolyte; and at least one seal, wherein each of the at least one seals is disposed intermediate between a first structural element and a second structural element of the fuel cell, wherein the seal comprises a first porous ceramic film disposed on the first structural element, a second porous ceramic film disposed on the second structural element and adjacent to the first porous ceramic film, and a filler material, wherein the filler material is interposed between the first porous ceramic film and the second porous ceramic film and/or impregnated into at least a portion of pores of the first porous ceramic film and the second porous ceramic film.

A method for making a joint comprises disposing a first porous ceramic film on a first structural element, disposing a second porous ceramic film on a second structural element, placing the first porous ceramic film adjacent to the second porous ceramic film; and impregnating a filler material into at least a portion of the pores of the first porous ceramic film and the second porous ceramic film effective to provide a seal between the first structural element and the second structural element.

### BRIEF DESCRIPTION OF THE DRAWINGS

Referring now to the Figures, which are exemplary embodiments, and wherein the like elements are numbered alike:

FIG. 1 is a schematic representation of two joints;

FIG. 2 is a cross-sectional view of a repeating unit of a planar fuel cell stack illustrating various locations for seal placement;

FIG. 3 is a scanning electron microscope image of an Al₂O₃—YSZ ceramic film and NiAl bond coat deposited on a Fe—Cr substrate;

FIG. 4 is a graphical representation of the thermal cycling profile and leak rate for a joint; and

FIG. 5 is a scanning electron microscope image of a glass filler and a porous ceramic film.

### DETAILED DESCRIPTION

Joints, seals and methods of making and using the joints and seals are described herein. The joint generally comprises two structural elements held together by a seal. As used herein, the term “structural element” generically refers to an outer member having a surface, which is joined to a surface of another outer member by means of the seal. As used herein, the term “seal” refers to an article intermediate to, and which mates or joins, two structural elements.

Also as used herein, the terms “first,” “second,” “bottom,” “top,” and the like do not denote any order or importance, but rather are used to distinguish one element from another, and the terms “the”, “a” and “an” do not denote a limitation of quantity, but rather denote the presence of at least one of the referenced item. Furthermore, all ranges reciting the same quantity or physical property are inclusive of the recited endpoints and independently combinable. The modifier “about” used in connection with a quantity is inclusive of the stated value and has the meaning dictated by the context or includes at least the degree of error associated with measurement of the particular quantity.

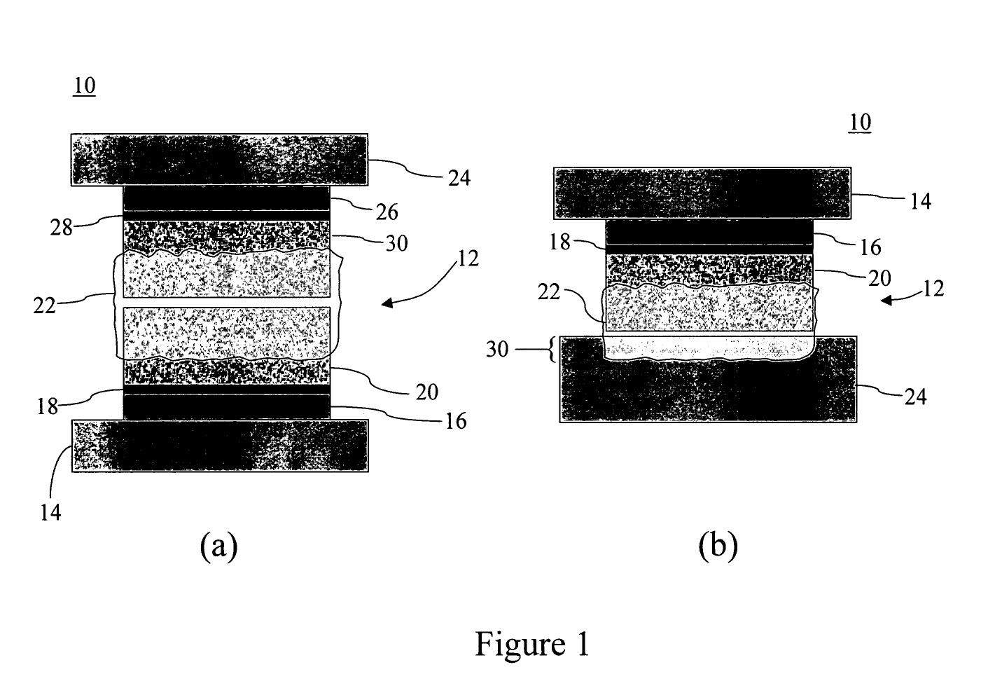

For illustrative purposes, two exemplary joints 10 are shown in FIG. 1. The joints 10 generally include a seal 12 disposed between a first structural element 14 and a second structural element 24. The seal 12 includes a first porous ceramic film 20 disposed on the first structural element 14, a second porous ceramic film 30 disposed on the second structural element 24, as well as a filler material 22 interposed between, and/or impregnated into at least a portion of the pores of, both the ceramic films 20 and 30. The first porous ceramic film 20 is adjacent to, and may optionally be in contact with, the second porous ceramic film 30.

As seen in FIG. 1 (a), the seal 12 may further include an optional first bond coat 16 disposed between the first structural element 14 and the first porous ceramic film 20, and/or an optional second bond coat 26 intermediate between the second structural element 24 and the second porous ceramic film 30. The optional first bond coat 16 and/or the optional second bond coat 26 can be disposed directly onto a surface of the first and/or second structural elements, respectively. A bond coat is desirable in situations where adhesion between the porous ceramic film and the structural element is not optimal.

Also, as shown in FIG. 1 (a), the seal 12 may further include an optional first corrosion resistant oxide layer 18 that can be disposed (e.g., by a deposition technique and/or by natural thermal growth) between the first structural element 14 (or the optional first bond coat 16) and the first porous ceramic film 20, and/or an optional second corrosion resistant oxide layer 28 disposed between the second structural element 24 (or the optional second bond coat 26) and the second porous ceramic film 30. The corrosion resistant oxide film is desirable in situations where the porous ceramic film and/or the filler material and the structural element (or the optional bond coat) may not be inert to each other over time. As used herein, the terms “coat”, “coating”, “film”, and “layer” are interchangeable and do not denote any limitation of size.

The joint 10 is generally made by disposing the first porous ceramic film 20 on the first structural element 14, disposing the second porous ceramic film 30 on the second structural element 24, placing the first porous ceramic film 20 adjacent to the second porous ceramic film 30, and interposing the filler material 22 between the first porous ceramic film 20 and the second porous ceramic film 30 and/or impregnating the filler material 22 into at least a portion of the pores of the first porous ceramic film 20 and the second porous ceramic film 30 effective to provide the seal 12 between the first structural element 14 and the second structural element 24.

When the optional bond coats and/or the optional corrosion resistant oxide layers are included in the joint, they are disposed on the structural elements prior to the porous ceramic films. For example, for the joint 10 shown in FIG. 1 (a), the bond coats 16 and 26 are first disposed on the structural elements 14 and 24, respectively. This is followed by formation (e.g., by a deposition technique and/or by natural thermal growth) of the corrosion resistant oxide layers 18 and 28, respectively. The porous ceramic films 20 and 30 are then disposed on the corrosion resistant oxide layers 18 and 28, respectively. The joint 10 is complete upon sufficient interposition and/or impregnation of the filler material 22.

It is important to note that if the second structural element 24 is a ceramic and no intermediate optional bond coat 26 or corrosion resistant oxide layer 28 exists, then the second porous ceramic film 30 is simply an outer portion of the second structural element 24 and is not a different layer. This situation is illustrated in FIG. 1 (b). Thus, in such situations, the filler material 22 is impregnated into the pores of the first porous ceramic film 20 and the outer portion of the second structural element 24 (which effectively serves as the second porous ceramic film 30 without requiring an extra processing step of disposing such a layer of the same composition) and/or interposed between the first porous ceramic film 20 and the outer portion of the second structural element 24.

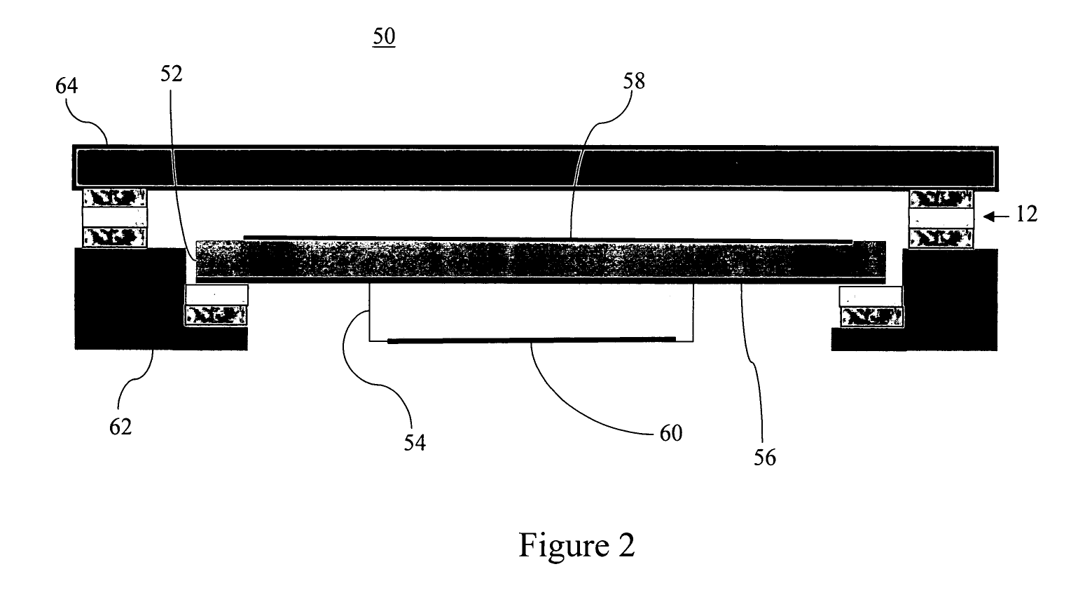

In one embodiment, the first and second structural elements 14 and 24, respectively, are components of a fuel cell system, such as a solid oxide fuel cell. FIG. 2 depicts a repeat unit in such a fuel cell system 50, and its structural components, which generally include an anode 52, a cathode 54, and an electrolyte 56. The fuel cell repeat unit 50 optionally may include an anode current collector 58 and a cathode current collector 60. The fuel cells are contained within a fuel cell housing, which may include a metal frame component 62 and a metal interconnect plate 64. Electrical contact layers (not shown) are placed both between the anode current collector 58 and the interconnect component 64 as well as between the cathode current collector 60 and the interconnect component 64 of another adjacent repeating unit 50.

Also shown in FIG. 2 are a few of the various locations within a fuel cell system 50 where a seal 12 may be placed. In one embodiment, a joint 10 may be formed by placing a seal 12 between two metal structural elements (e.g., between a metal frame component 62 and a metal interconnect component 64). In another embodiment, a joint 10 may be formed by placing a seal 12 between a metal structural element and a ceramic structural element (e.g., between a metal frame component 62 and the electrolyte 56). In yet another embodiment, a joint 10 may be formed by placing a seal 12 between two ceramic structural elements (e.g., between a ceramic frame component (not shown) and a ceramic cell component such as the anode 52).

A single fuel cell generally produces only a small voltage (e.g., about 1 Volt in an open circuit). As a result, multiple fuel cells are often stacked in series to increase the voltage produced and, consequently, the usable electrical power. Multiple fuel cells may be stacked in any fashion and/or geometry. Accordingly, there are a number of factors that influence the choice of seal composition in order to obtain a hermetic or near-hermetic seal. Seal composition will depend not only on the stack configuration and the choice of structural elements between which they will be placed, but also the chemicals (e.g., fuel and oxidant) and conditions (e.g., temperature, pressure, and the like) to which they will be exposed.

The first and/or second structural element may be formed from any materials between which a seal is needed, including for example metals, alloys, ceramics, ceramic composites, and ceramic-metal composites (cermets). Suitable alloys for use in the structural elements include heat resistant alloys such as Ni- and/or Fe-base superalloys, Cr-base alloys, stainless steel alloys, and the like, and combinations comprising at least one of the foregoing alloys. Suitable ceramics for use in the structural elements include doped and undoped binary, ternary, or other multinary oxides of transition-, rare-earth-, and main group-metals including, without limitation, alumina (Al₂O₃), zirconia (ZrO₂), chromia (Cr₂O₃), titania (TiO₂), doped lanthanum chromite (La₁₋ₓCaₓCrO₃), lanthanum manganate LaMnO₃, and the like, and a combination comprising at least one of the foregoing oxide-based ceramics. Suitable ceramic composites for use in the structural elements include any of the aforedescribed suitable ceramic compositions and a soft phase ceramic composition such as silica (SiO₂), ceria (CeO₂), yttria (Y₂O₃), and a combination comprising at least one of the foregoing compositions. Suitable cermets include any metal such as Au, Cu, Pt, Ni, and a ceramic or ceramic composite such as those described above.

Suitable materials for use as the first and/or second porous ceramic films include any of the aforedescribed suitable ceramics, ceramic composites, and cermets. The specific materials used to form the first and/or second porous ceramic films are chosen based on the conditions to which they will be exposed. Thermal and chemical phase stability, thermal shock resistance, adhesive strength, electrical properties, coefficient of thermal expansion (CTE), and wetability/impregnability to the filler material are a few of the properties of the ceramic material that should be considered when selecting the composition. This can be done by one of ordinary skill in the art without undue experimentation. For example, an Al₂O₃ top coat is not ideal for high temperature fuel cells where resistance to thermal cycling is the primary criteria. However, by incorporating ZrO₂ or ZrO₂—Y₂O₃ (YSZ) to an Al₂O₃ matrix, Al₂O₃—ZrO₂ or Al₂O₃—YSZ composites are rendered suitable for these conditions owing to their superior thermal stability and toughness. Furthermore, by varying the ratio of Al₂O₃ to ZrO₂ or YSZ, the composition can be tailored to meet the requirements of a specific application. In an exemplary embodiment, the first and second porous ceramic films are made of an Al₂O₃—ZrO₂ composite.

In one embodiment, the porous ceramic films are nanostructured. As used herein, the term “nanostructured” refers to those materials having average grain size dimensions of less than or equal to about 100 nanometers. Such materials can have superior properties compared to those with larger grain sizes including improved crack resistance, strain tolerance, and adhesion strength.

In one embodiment, the porous ceramic films are about 100 nanometers to about 1 millimeter thick. In another embodiment, the porous ceramic films are about 1 micrometer to about 700 micrometers thick. In yet another embodiment, the porous ceramic films are about 50 micrometers to about 500 micrometers thick.

The porous ceramic films exhibit three-dimensional porosity of about 1 to about 50 volume percent (vol %) based on the total volume of the film. In an exemplary embodiment, the porous ceramic films exhibit three-dimensional porosity of about 10 to about 20 vol %. The individual pores may be micrometer sized (about 1.0 to about 50 micrometers), submicrometer sized (about 0.1 to about 1.0 micrometer), nanometer sized (up to about 100 nanometers) or a combination of two or more of the foregoing.

The filler material may be any glass or glass-ceramic composite comprising SiO₂ and will not volatilize or have other detrimental chemical interactions with other components of the joint or its environs. Suitable compositions include, without limitation, aluminosilicates (Al₂O₃—SiO₂), CaO—MgO—Al₂O₃—SiO₂ composites, SiO₂—SrCe_{0.95}Tb_{0.05}O₃—NaAlO₂ composites, borosilicates (B₂O₃—SiO₂), barium-doped Al₂O₃—SiO₂, SiO₂—CaO—B₂O₃—Al₂O₃ composites, BaO—CaO—Al₂O₃—SiO₂ composites CaO—Al₂O₃—SiO₂ composites, BaO—La₂O₃—SiO₂ composites, and those compositions described in U.S. Pat. Nos. 6,532,769 and/or 6,430,966, herein incorporated by reference in their entireties.

Alternatively, the filler material may be a foil of a metal or alloy that will not melt, that have high oxidation resistance, or have other detrimental chemical interactions with other components of the joint or its environs. For example, in high temperature applications (e.g., above about 500° C.), refractory metals would be especially useful because of their high melting temperatures and high oxidation resistance. Specific refractory metals include W, Re, Os, Ta, Mo, Ir, Nb, Ru, Hf, Rh, V, Y, and Cr. A suitable refractory alloy includes FeCrAlY.

When the filler material is a glass or glass ceramic composite, it may be interposed between the first and second porous ceramic films, impregnated in the pores of the first and second porous ceramic films, or both. In this fashion, the seal can be a bonded seal or a compressive seal. However, when the filler material is a metal foil or film, it will only be interposed between the first and second porous ceramic films, and the seal functions as a compressive seal.

The optional first and/or second bond coat may be formed from any material that facilitates adhesion or bonding between the structural element and the porous ceramic film. Desirably the bond coat material is dense and substantially oxidation resistant. In one embodiment, the bond coat has the composition MCrAlX, wherein M comprises Ni, Co, Fe, or a combination comprising at least one of the foregoing and X comprises Y, Zr, Hf, Yb, or a combination comprising at least one of the foregoing. In another embodiment, the bond coat has the composition MAl, wherein M comprises Ni, Co, Fe, or a combination comprising at least one of the foregoing. In one embodiment, the bond coats are nanostructured.

In one embodiment, the bond coats are about 100 nanometers to about 200 micrometers thick. In another embodiment, the bond coats are about 1 micrometer to about 100 micrometers thick. In yet another embodiment, the bond coats are about 10 micrometers to about 50 micrometers thick.

In one embodiment, the overall seals are about 1 micrometer to about 3 millimeter thick. In another embodiment, the overall seals are about 50 micrometers to about 1500 micrometers thick. In yet another embodiment, the overall seals are about 100 micrometers to about 500 micrometers thick.

The porous ceramic films and optional bond coat may be prepared using any known deposition method such as thermal spray, chemical vapor deposition, physical vapor deposition, sputtering, ion plating, cathodic arc deposition, atomic layer epitaxy, molecular beam epitaxy, or the like, or a combination comprising at least one of the foregoing. In an exemplary embodiment, thermal spray is used. Thermal spray techniques include coating processes in which a coating is applied to a substrate by deposition of materials in a molten or semi-molten state. Thermal spray may be performed with a detonation gun, a plasma gun, or a high velocity oxygen fuel (HVOF) gun. For ceramic and ceramic composite coatings, plasma thermal spray is more favorable, while HVOF is more favorable for cermet-containing film deposition. Thermal spray procedures are described in, for example, U.S. Pat. Nos. 6,447,848, 6,025,034, and/or 6,277,448, herein incorporated by reference in their entireties.

The optional corrosion resistant oxide layers may be prepared by oxidizing a layer of the structural elements or bond coats. The oxidation can comprise heating, electrolytic anodizing, passivating in an acid bath (e.g., nitric, sulfuric, phosphoric, or the like), or the like. Alternatively, the oxide layers may be deposited using many of the deposition techniques described above.

In one embodiment, the corrosion resistant oxide layer is about 100 nanometers to about 200 micrometers thick. In another embodiment, the corrosion resistant oxide layer is about 1 micrometer to about 100 micrometers thick. In yet another embodiment, the corrosion resistant oxide layer is about 10 micrometers to about 50 micrometers thick.

Impregnating the glass or glass ceramic composite filler material into the pores of the porous ceramic films can be achieved by heating the filler material, applying pressure, and cooling. In one embodiment, the filler material is placed in between the two porous ceramic films and heated until it is softened or until it flows to a degree effective to wick into the pores when pressure is applied. Pressure is applied to one or both of the structural elements until the filler has been sufficiently impregnated into the pores of both porous ceramic films, at which time the joint is cooled to allow the filler to harden or resolidify in the pores. If the two porous ceramic films are brought into contact before cooling, the extent of the pressure applied to the structural elements will determine whether any filler material remains interposed between the two porous ceramic films.

In another embodiment, the two porous ceramic films are placed adjacent to each other, and optionally contact each other. The filler material is placed on a side of the two porous ceramic films and heated until it is softened or until it flows. Vacuum or pressure or both is applied to the softened or flowing filler material until the filler has been sufficiently impregnated into the pores of both porous ceramic films. Once impregnated, the filler is cooled and allowed to harden or solidify in the pores of the porous ceramic films and/or in between the two porous ceramic films.

In yet another embodiment, the glass or glass ceramic composite filler can be deposited on the surface of one or both of the porous ceramic films, and the seal can be formed by bringing the two filler-coated porous ceramic films together under heat and/or pressure. Many of the deposition techniques described above can similarly be used for depositing the glass or glass ceramic composite filler on one or both of the porous ceramic films. In an exemplary embodiment, the filler is deposited on the surface of one or both porous ceramic films using thermal spray.

Alternatively, instead of depositing the glass or glass ceramic composite filler on the surface of one or both of the porous ceramic films, each porous ceramic film can be deposited at the same time as the glass or glass ceramic composite filler such that a gradient is formed wherein the volume fraction of the filler increases as the distance from the substrate increases until there is only filler being deposited. Thus, in this manner, the porous ceramic film(s) also contain the filler materials described above prior to forming the seal.

Advantageously, in the event that there is a leak in the seal, the seal may be regenerated by heating the filler material within the seal to a temperature above its softening point followed by cooling after sufficient regeneration of the seal. Alternatively, the seal may be regenerated by simply repeating the impregnation process with additional filler material (i.e., heating the additional filler material, applying pressure to allow the additional filler material to enter the pores of the porous ceramic film, and cooling the additional filler material).

Interposing the metal foil filler material between the porous ceramic films can be achieved using a variety of techniques. For example, the filler material can be deposited on one or both of the porous ceramic films and the seal can be formed by bringing the two porous ceramic films together under pressure. Many of the deposition techniques described above can similarly be used for depositing the metal foil filler on one or both of the porous ceramic films. Alternatively, a metal foil can be fabricated separately and simply placed in between the two porous ceramic films. The application of pressure to one or both of the structural elements creates a compressive seal therebetween.

In addition, before any of the steps described above for making the joint is carried out, a surface treatment step, such as a grinding, polishing, rinsing, etching, grit blasting, and the like, may be performed in order to enhance the overall properties of the joint.

While not wishing to be bound by theory, it is believed that by having a seal comprising different components, in contrast to the prior art, there is a gradual transition of thermal-elastic properties from the structural elements to the filler material, which advantageously minimizes stress and/or degradation of the joint. For example, filler materials that ordinarily would not be capable of being used with a particular structural element can now be employed (e.g., low softening point vitreous glass can now be used with metal structural elements in a SOFC and not suffer corrosion). Furthermore, the interpenetrating interface between the impregnated filler material and the porous ceramic films are beneficial for crack deflection and arrest, which result in improved seal fracture toughness. Consequently, the seals and joints described herein may have increased service lifetimes and/or undergo more rapid thermal cycling compared with seals and joints of the prior art.

It should be recognized by those skilled in the art in view of this disclosure that the composite seals, as described herein may not only be used in solid oxide fuel cells, but are broadly applicable to any situation wherein one metal and one ceramic, two metal, or two ceramic structures can be interconnected. Such examples include, without limitation, other high temperature electrochemical devices, gas generation devices, gas separation devices, other types high temperature fuel cells, electrolyzers, and the like.

This disclosure is illustrated by the following examples:

### EXAMPLE 1

### Fabrication of Porous Ceramic Film for Composite Joint

In this example, a porous Al₂O₃—YSZ composite film was prepared on a Fe—Cr alloy substrate. Prior to depositing the ceramic film, a NiAl (4.5 weight percent (wt %) Al, based on the total weight of the NiAl) bond coat was deposited on the substrate to enhance the bond between the ceramic film and the substrate.

Powdered YSZ (8 wt % yittria) and alumina were mechanically mixed together such that individual mixtures containing from about 5 to about 40 vol % YSZ were formed. An automatic atmospheric plasma spray (APS) system (Sulzer-Metco) equipped with a 9 MB plasma gun, a turntable, and a six-axis robot was used to deposit both the bond coat and the porous ceramic film onto the substrate. Plasma spray parameters (e.g., Ar/H₂ working gases, spray distance powder feed rate, and transverse speed, among others) were optimized for each feedstock mixture of Al₂O₃ and YSZ.

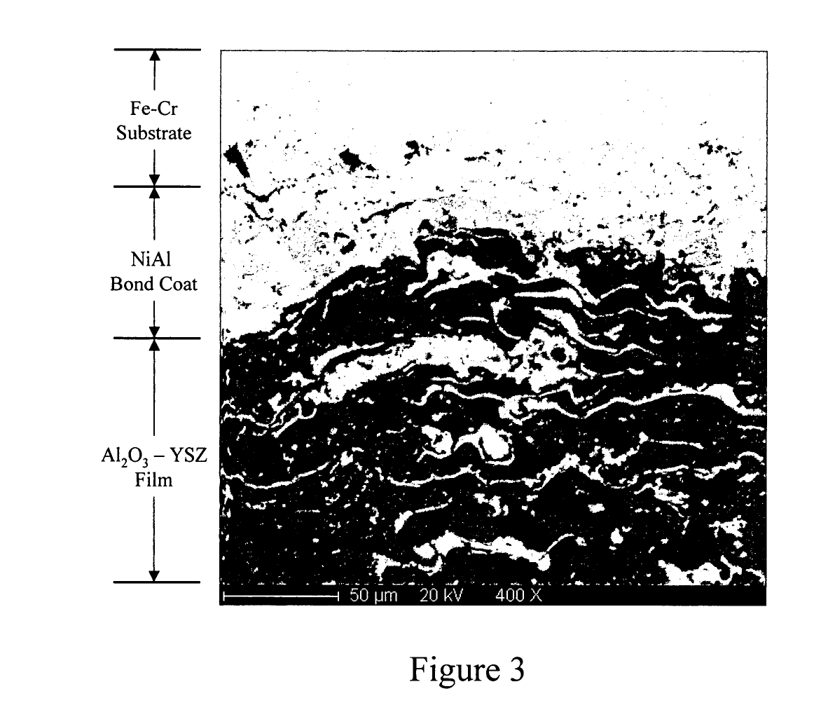

The thickness of the NiAl alloy bond coat was about 80 to about 100 micrometers, and the thickness of the Al₂O₃—YSZ composite film was about 200 to about 350 micrometers. A back-scattered scanning electron microscope (SEM) image of a polished cross-section of the coated Fe—Cr substrate, obtained using a Cameca SX50 system, is shown in FIG. 3. As seen in FIG. 3, there is a layered structure. Within the Al₂O₃—YSZ composite film, YSZ splats can be seen as the brighter regions distributed within the darker regions of Al₂O₃ splats. X-ray diffraction (Bruker) verified the presence of only the tetragonal zirconia phase and a face-centered cubic alumina phase.

The Al₂O₃—YSZ composite film sample containing 20 vol % YSZ had an area specific resistance of 9.25 kilo-Ohms centimeter squared (kΩ*cm²) at 800° C. and 2.61 kΩ*cm² at 920° C., which will ensure electrical isolation in high temperature fuel cells.

Button samples, having 25 millimeter diameters, of the composite films were subjected to thermal shock tests where they were heated to 850° C., allowed to dwell for 15 minutes, and quenched in a cold water bath. This thermal cycling process was repeated three times for each sample. No spallation was observed for any of the button samples. In additon, visual examination indicated the coatings remained intact.

Button samples of the composite films were further subjected to tensile adhesion strength tests (ASTM C633-01). Specifically, steel pull rods were bonded to the either side of the coated button sample using FM1000 epoxy adhesive (Cytec Engineered Materials Inc). The pull-out bar was connected through two universal joints to a servo hydraulic loading frame (Instron). The samples were pulled apart with a cross-head speed of 0.015 millimeters per second (mm/sec). 5 samples were tested, and the average tensile strenth of the coating was 31.97 mega-Pascals (Mpa) with a standard deviation of 7.63 Mpa, indicating that a strong bond was formed with the Fr—Cr substrate. The fractured surface showed that the cracks propagted partially through the NiAl bond coat and partially through the Al₂O₃—YSZ composite film.

Using a mercury intrusion porosimeter (Quantachrome Corporation), the pores within the Al₂O₃—YSZ composite film were determined to occupy about 14.2 percent of the total volume. To determine whether the pores within the composite film formed continuous leak paths, the bulk permeability of the ceramic film was measured. A test cell was formed by placing an annular silicon gasket between two button samples of the composite film such that a chamber was defined. The sealed chamber of the test cell was pressurized with helium gas and the leak rate was measured by monitoring the steady state flow rate of the helium gas. The tests were conducted at room temperature with varying compressive forces. The leak rate was determined to be negligible, i.e., less than about 0.1 standard cubic centimeters per minute (sccm) at pressures greater than about 150 pounds per square inch (psi). Consequently, it was concluded that the majority of the pores within the ceramic composite film did not form continuous leak paths.

### EXAMPLE 2

### Fabrication of a Glass-Filled Joint

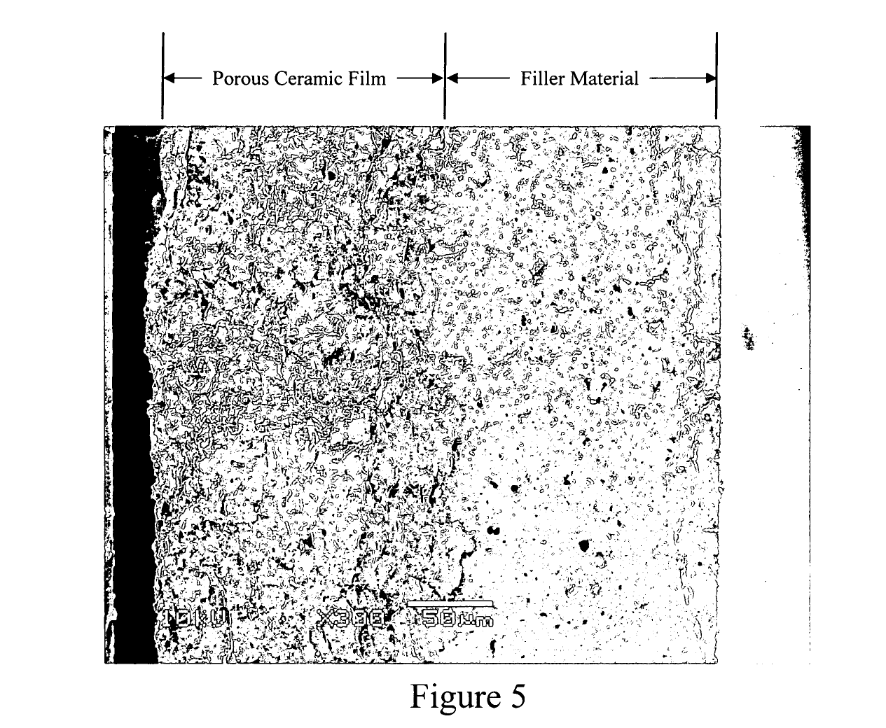

A joint was formed by impregnating a glass filler material into the pores of two mated 1.5 inch diameter button samples of the composite ceramic film. The filler was only placed in the 6 millimeter wide annular region of the disks, hence a sealed chamber was formed. A cross sectional area of the seal can be seen in the SEM image of FIG. 5.

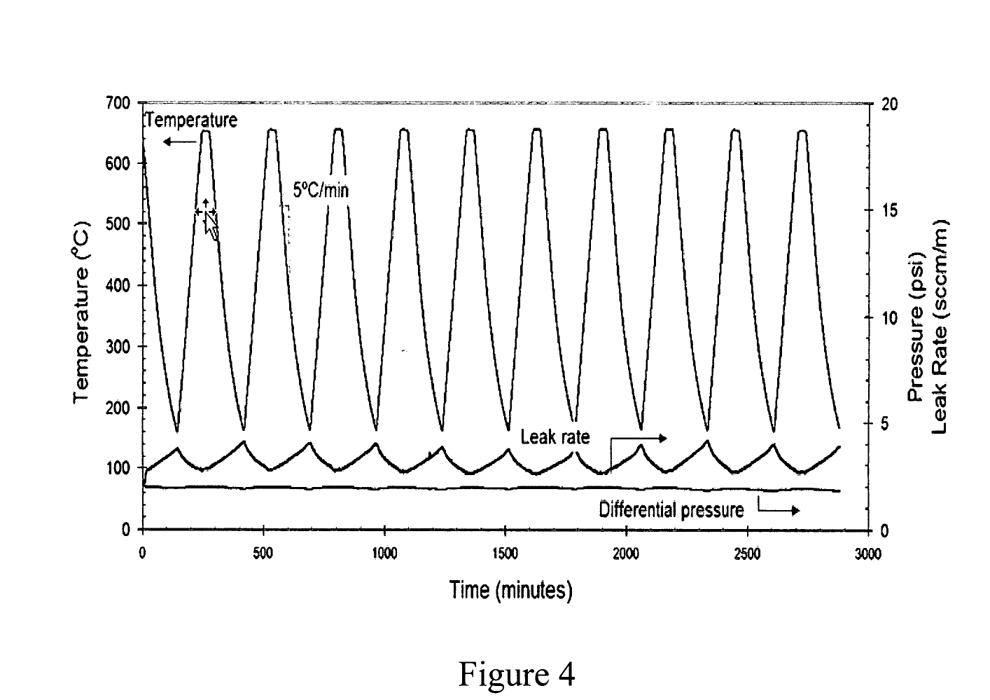

The joint was subjected to thermal cycling between 800° C. and 150° C. using a ramp rate of about 5° C. per minute. The sealed chamber was filled with helium gas and maintained at about 13.8 Kpa. At steady state, the leak rate of the seal (and ultimately the joint) was determined to be 0.016 standard cubic centimeters per centimeter (sccm/cm) seal line length. After 40 cycles, leak rates of less than about 0.017 sccm/cm were observed. After 80 cycles, leak rates of less than about 3.1 sccm/cm were observed. FIG. 4 illustrates the data collected for the last 10 cycles of an 80-cycle test.

These results indicate that the composite joint of this example was able to withstand significantly higher heating and cooling rates than observed during startup and shutdown of SOFC stacks (less than or equal to about 1° C. per minute), while maintaining equivalent or superior leak rates.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A joint, comprising:
a first structural element;
a second structural element; and
a seal intermediate between the first structural element and the second structural element, wherein the seal comprises a first porous ceramic film disposed on the first structural element, a second porous ceramic film disposed on the second structural element and adjacent to the first porous ceramic film, and a filler material, wherein the filler material is interposed between the first porous ceramic film and the second porous ceramic film and/or impregnated into at least a portion of pores of the first porous ceramic film and the second porous ceramic film.

2. The joint of claim 1, wherein the first and/or second structural element is a metal, alloy, ceramic, ceramic composite, or ceramic-metal composite.

3. The joint of claim 1, wherein the first and/or second porous ceramic film is about 100 nanometers to about 1 millimeter thick.

4. The joint of claim 1, wherein the filler material is a glass or glass-ceramic composite comprising SiO₂.

5. The joint of claim 1, wherein the first porous ceramic film is in contact with the second porous ceramic film.

6. The joint of claim 1, further comprising a first bond coat disposed between the first structural element and the first porous ceramic film and/or a second bond coat disposed between the second structural element and the second porous ceramic film.

7. The joint of claim 1, wherein the first and second porous ceramic films independently comprise a binary, ternary, or other multinary oxide of a transition, rare-earth, or main group metal.

8. The joint of claim 7, wherein the first and second porous ceramic films independently further comprise a glass composition comprising SiO₂.

9. The joint of claim 6, wherein the first and/or second bond coat is about 100 nanometers to about 200 micrometers thick.

10. The joint of claim 1, further comprising a first corrosion resistant oxide layer disposed between the first porous ceramic film and the first structural element or first bond coat and/or a second corrosion resistant oxide layer disposed between the second porous ceramic coating and the second structural element or second bond coat.

11. The joint of claim 10, wherein the first and/or second corrosion resistant oxide layer is about 100 nanometers to about 200 micrometers thick.

12. The joint of claim 1, wherein the seal is about 1 micrometer to about 3 millimeters thick.

13. The joint of claim 1, wherein the seal is hermetic.

14. A fuel cell, comprising:
a fuel cell housing;
an anode;
a cathode;
an electrolyte, wherein the anode and the cathode are on opposite sides of the electrolyte; and
a seal disposed intermediate between a first structural element and a second structural element of the fuel cell, wherein the seal comprises a first porous ceramic film disposed on the first structural element, a second porous ceramic film disposed on the second structural element and adjacent to the first porous ceramic film, and a filler material, wherein the filler material is interposed between the first porous ceramic film and the second porous ceramic film and/or impregnated into at least a portion of pores of the first porous ceramic film and the second porous ceramic film.

15. The fuel cell of claim 14, wherein the first structural element and the second structural element are selected from the group consisting of the fuel cell housing, the anode, the cathode, and the electrolyte.

16. The fuel cell of claim 14, wherein the fuel cell is a solid oxide fuel cell.

17. The fuel cell of claim 14, wherein the first porous ceramic film is in contact with the second porous ceramic film.

18. The fuel cell of claim 14, further comprising a first bond coat disposed between the first structural element and the first porous ceramic film and/or a second bond coat disposed between the second structural element and the second porous ceramic film.

19. The fuel cell of claim 14, further comprising a first corrosion resistant oxide layer disposed between the first porous ceramic film and the first structural element or first bond coat and/or a second corrosion oxide layer disposed between the second porous ceramic coating and the second structural element or second bond coat.

20. The fuel cell of claim 14, wherein the seal is about 1 micrometer to about 3 millimeters thick.

21. The fuel cell of claim 14, wherein the seal is hermetic.

22. A method for making a joint, comprising:
disposing a first porous ceramic film on a first structural element;
disposing a second porous ceramic film on a second structural element;
placing the first porous ceramic film adjacent to the second porous ceramic film; and
impregnating a filler material into at least a portion of the pores of the first porous ceramic film and the second porous ceramic film effective to provide a seal between the first structural element and the second structural element.

23. The method of claim 22, further comprising:
disposing a first bond coat on the first structural element prior to disposing the first porous ceramic film on the first structural element; and/or
disposing a second bond coat on the second structural element prior to disposing the second porous ceramic film on the second structural element.
